(19) United States
(12) Patent Application Publication
(10) Pub. No.: US 2026/0242159 A1
(43) Pub. Date: Aug. 20, 2026

(54) Metering System for an Agricultural Distribution Machine and Method for Metering

(71) Applicant: Amazonen-Werke H. Dreyer SE & Co. KG, Hasbergen (DE)

(72) Inventors: Jan-Eike LÜBBEN, Edewecht (DE); Daniel MERTENS, Oldenburg (DE); Thomas WIEN, Stuhr (DE)

(73) Assignee: Amazonen-Werke H. Dreyer SE & Co. KG, Hasbergen (DE)

(21) Appl. No.: 19/164,650

(22) PCT Filed: Feb. 28, 2024
(86) PCT No.: PCT/EP2024/055062

§ 371 Date: Sep. 12, 2025

(30) Foreign Application Priority Data
Mar. 15, 2023 (DE) 10 2023 106 468.1

(51) Int. Cl. B65G 53/66; A01C 15/04

(52) U.S. Cl. CPC B65G 53/66; A01C 15/04

(57) ABSTRACT

A metering system for an agricultural distribution machine, a device arrangement comprising at least one flow generator for generating a conveyor airflow flowing in the conveying direction and a metering airflow, a metering device which is configured to meter distribution material using a partial metering airflow generated from the metering airflow, and a distribution system via which distribution material can be conveyed from a storage container to the metering device.

### CROSS REFERENCE TO RELATED APPLICATIONS

The present application claims priority under 35 U.S.C. § 365 to PCT/EP2024/055062 filed on Feb. 28, 2024 and under 35 U.S.C. § 119(a) to German Application No. 10 2023 106 468.1 filed on Mar. 15, 2023, both of which are incorporate by reference in their entireties.

### TECHNICAL FIELD

The disclosure relates to a metering system for an agricultural distribution machine and a method for metering distribution material.

### BACKGROUND

Conventional metering systems typically comprise a device assembly with at least one flow generator. The device assembly generates a conveyor airflow in a conveying direction and a metering airflow. A metering device then meters the distribution material to be dispensed using a partial metering airflow generated from the metering airflow. The distribution material is conveyed from a storage container to the metering device using the conveyor airflow.

With known metering systems, there is a risk, in particular when metering fine seeds such as rapeseed, that the distribution material will flow in the opposite direction to the conveyor airflow and thus in the direction of the flow generator if the conveyor airflow is reduced or absent. The flow generator can be damaged by the return flow of distribution material. There is also a risk that the distribution material will be unintentionally forced out of the flow generator and thus end up on the agricultural field in an uncontrolled manner.

If the conveyor airflow is generated hydraulically via the tractor hydraulics, in some operating situations, such as when hydraulically lifting an implement carrier of the distribution machine, there may be insufficient hydraulic power available to generate a sufficient conveyor airflow, which can result in material backflow through the metering airflow.

### SUMMARY

One task underlying the disclosure is therefore to prevent unintentional backflow of the distribution material against the conveying direction when the conveyor airflow is reduced or absent.

The task can be solved by a metering system of the type mentioned above, wherein the metering system according to the disclosure comprises a backflow prevention device by means of which, in the event of reduced or absent conveyor airflow, the introduction of distribution material located in the distribution system into the flow generator of the device assembly can be prevented via one or more metering airflows flowing in the opposite direction to the conveying direction.

Damage to the flow generator by backflowing distribution material can be effectively prevented by the backflow prevention device. Unintentional expulsion of distribution material from the flow generator is also prevented. A reduced or absent conveyor airflow can occur due to an interruption or restriction in the generation of the conveyor airflow or due to a defect, for example a line defect or a leak. A reduced or absent conveyor airflow with simultaneous active metering airflow can occur in particular when switching the airflow generation on and off. During normal operation, a partial conveyor airflow generated from the conveyor airflow and a partial metering airflow generated from the metering airflow are combined in the metering device so that the distribution material is conveyed in the direction of the agricultural field via the combined airflow. The flow generator can be provided as a blower, for example.

In a preferred embodiment of the metering system according to the disclosure, the backflow prevention device comprises at least one movable or deformable blocking valve, by means of which a free flow cross-section through the backflow prevention device can be partially or completely closed. The backflow prevention device is preferably a passive component that cannot be controlled by an electronic control device. The backflow prevention device can comprise one or more pivotable blocking valves. The at least one movable blocking valve is preferably rotatable in the flow cross-section. When the blocking valve is fully open, the blocking valve is aligned parallel to the direction of flow, for example. The blocking valve can be provided as a disc-shaped element. The blocking valve can be a centric blocking valve. The blocking valve can be a single, double, or triple eccentric blocking valve. The backflow prevention device can comprise one or more stops for the one or more blocking valves. The blocking valve can be made from an elastically deformable material. In this case, the free flow cross-section is released and closed by deformation of the blocking valve. The backflow prevention device can, for example, be a check valve.

In another preferred embodiment of the metering system according to the disclosure, the backflow prevention device is configured to be actuated by the airflow passing through the backflow prevention device. When the backflow prevention device is flowed through in the conveying direction, the backflow prevention device is preferably in an open state in which the backflow prevention device can be flowed through by an airflow comprising distribution material. When the backflow prevention device is flowed through or flowed onto against the conveying direction, the backflow prevention device is in a closed state in which the distribution material cannot flow through or pass the backflow prevention device. In the closed state, the backflow prevention device can either also be impassable for the airflow, or the airflow can continue to flow through the backflow prevention device, in particular in a highly restricted manner, so that there is a high flow resistance against the conveying direction. The backflow prevention device may comprise a blocking device, in particular a blocking valve, which has a flow resistance dependent on the conveying direction, so that the blocking device can be actuated, preferably exclusively, by the airflow passing through it. For example, such a blocking device can have a low flow resistance in the direction of flow, so that the conveyor airflow can pass through it with at least approximately no loss. In the opposite direction to the direction of flow, however, the blocking device can have a high flow resistance, so that an airflow comprising the distribution material is prevented.

In another preferred embodiment of the metering system according to the disclosure, the backflow prevention device comprises an actively controllable actuator for opening and/or closing the backflow prevention device. The actuator can comprise a controllable actuator. The actuator can be an electrically, pneumatically, or hydraulically driven actuator. In this embodiment, the backflow prevention device can also be used as an actively controllable throttle device to regulate airflows in and against the conveying direction.

In a further preferred embodiment of the metering system according to the disclosure, the distribution system comprises a main distribution unit into which the distribution material and the conveyor airflow can be introduced and which is configured to distribute the distribution material to several partial conveyor airflows generated from the conveyor airflow. The main distribution unit preferably comprises at least one air inlet for the conveyor airflow and several air outlets for the partial conveyor airflows. Furthermore, the main distribution unit preferably comprises a material inlet opening for the distribution material. The main distribution unit is preferably arranged below a storage container for the distribution material so that the distribution material can enter the main distribution unit via the material inlet opening under the influence of gravity.

In a further preferred embodiment of the metering system according to the disclosure, the device assembly comprises a conveyor airflow generator for generating the conveyor airflow and a metering airflow generator for generating the metering airflow. The backflow prevention device is preferably arranged between the conveyor airflow generator of the device assembly and the main distribution unit of the distribution system. The conveyor airflow generator is preferably a conveyor air blower. The metering airflow generator is preferably a metering air blower.

Furthermore, a metering system according to the disclosure is preferred in which the backflow prevention device is arranged between the main distribution unit of the distribution system and the metering device. In this case, the respective partial conveyor airflows can be divided into several, for example two, partial conveyor airflows by means of a dividing device. The dividing device can be, for example, a Y-piece. The backflow prevention device can be integrated into the dividing device.

Furthermore, a metering system according to the disclosure is advantageous in which the device assembly comprises a flow generator for generating a main airflow and a flow divider for generating the conveyor airflow and the metering airflow from the main airflow. The flow divider can comprise one or more switches or flaps for dividing the main airflow into the conveyor airflow and the metering airflow. In this case, it may happen that, at a specific switch or flap position, a pronounced metering airflow and, at the same time, a reduced or no conveyor airflow is generated, so that a backward material flow against the conveying direction can occur. In this case, the backflow prevention device can be used to prevent the distribution material in the distribution system from entering the flow generator of the device assembly.

In another preferred embodiment of the metering system according to the disclosure, the backflow prevention device is arranged between the flow divider of the device assembly and the main distribution unit of the distribution system or between the flow generator of the device assembly and the flow divider of the device assembly. If the backflow prevention device is arranged between the flow divider of the device assembly and the main distribution unit of the distribution system, a backward material flow does not enter the flow divider of the device assembly and thus also does not enter the flow generator due to the backflow prevention device. If the backflow prevention device is arranged between the flow generator of the device assembly and the flow divider of the device assembly, the distribution material can enter the flow divider of the device assembly in the event of a backward material flow, but not the flow generator of the device assembly.

Furthermore, a metering system according to the disclosure is preferred in which the metering device is provided as a metering device operated with overpressure. The metering device can comprise a rotationally driven metering rotor. The metering rotor can be a metering disc or a metering drum. The metering device can be a separation device which is operated with overpressure. The separation device can comprise a rotationally driven separation disc or separation drum.

The task underlying the disclosure is further solved by a method of the type mentioned at the outset, wherein, within the scope of the method according to the disclosure, the introduction of distribution material located in the distribution system into the flow generator of the device assembly is prevented in the event of reduced or absent conveyor airflow by means of one or more partial metering airflows flowing in the opposite direction to the conveying direction by means of a backflow prevention device of the metering system. The method according to the disclosure can, for example, be carried out with a metering system according to one of the embodiments described above. With regard to the advantages and modifications of the method according to the disclosure, reference is therefore first made to the advantages and modifications of the metering system according to the disclosure.

In a preferred embodiment of the method according to the disclosure, the backflow prevention device is actuated by the airflow passing through the backflow prevention device. The closed state of the backflow prevention device is preferably dependent on the direction of flow of the airflow flowing through or flowing onto the backflow prevention device. Alternatively or additionally, an actuator of the backflow prevention device is actively controlled to open and/or close the backflow prevention device.

In another preferred embodiment of the method according to the disclosure, the distribution material and the conveyor airflow are introduced into a main distribution unit of the distribution system, which distributes the distribution material into several partial conveyor airflows generated from the conveyor airflow. Preferably, a backflow of the distribution material is prevented by means of the backflow prevention device between a conveyor airflow generator of the device assembly and the main distribution unit of the distribution system. Alternatively, a backflow of the distribution material is prevented by means of the backflow prevention device between the main distribution unit of the distribution system and the metering device.

The method according to the disclosure is further advantageously developed in that the device assembly comprises a flow generator for generating a conveyor airflow, and the conveyor airflow and the metering airflow are generated from the main airflow by means of a flow divider. A backflow of the distribution material is prevented by means of the backflow prevention device, preferably between the flow divider of the device assembly and the main distribution unit of the distribution system. Alternatively, a backflow of the distribution material is prevented by means of the backflow prevention device between the flow generator of the device assembly and the flow divider of the device assembly.

### BRIEF DESCRIPTION OF THE DRAWINGS

Preferred embodiments of the disclosure are explained and described in more detail below with reference to the following accompanying drawings.

FIG. 1 shows a distribution machine with a metering system according to the disclosure in a schematic representation;

FIG. 2 shows a metering system according to the disclosure in a schematic representation;

FIG. 3 shows a further metering system according to the disclosure in a schematic representation;

FIG. 4 shows a further metering system according to the disclosure in a schematic representation;

FIG. 5 shows a further metering system according to the disclosure in a schematic representation;

FIG. 6 shows a schematic representation of a main distribution unit including a backflow prevention device of a metering system according to the disclosure;

FIG. 7 shows a backflow prevention device of a metering system according to the disclosure in an open state in a schematic representation; and

FIG. 8 shows a schematic representation of the backflow prevention device shown in FIG. 7 in a closed state.

### DETAILED DESCRIPTION

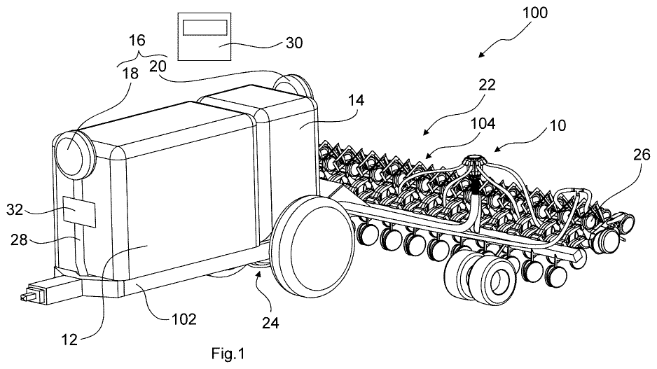

FIG. 1 shows an agricultural distribution machine 100, by means of which two different spreading materials, for example seed and fertilizer, can be distributed on to an agricultural field.

The agricultural distribution machine 100 is provided as an attachment and can be attached to a towing vehicle, such as a tractor, via a drawbar. The drawbar is connected to a main frame 102 of the distribution machine 100. The main frame 102 carries storage containers 12, 14 of a metering system 10 of the distribution machine 100. The storage containers 12, 14 can be used to carry the distribution material to be applied to the agricultural field. For example, granular fertilizer can be carried in the storage container 12. For example, seeds can be carried in the storage container 14.

The main frame 102 is connected to an implement carrier 104 of the distribution machine 100. Several deposition devices are arranged side by side on the implement carrier 104, via which a metered quantity of the distribution materials carried in the storage containers 12, 14 can be deposited on the agricultural field. The deposition devices can be provided, for example, as seed coulters and fertilizer coulters, wherein the seed coulters and fertilizer coulters can be, for example, disc coulters or tine coulters.

The metering system 10 of the distribution machine 100 includes a device assembly 16 which comprises a conveyor airflow generator 18 and a metering airflow generator 20. The conveyor airflow generator 18 generates a conveyor airflow FLS flowing in the conveying direction. The metering airflow generator 20 generates a metering airflow DLS. Several metering devices 26 are also arranged on the implement carrier 104, wherein the metering devices 26 serve to meter distribution material using a partial metering air metering airflow DLTS generated from the metering airflow DLS. The metering system 10 of the distribution machine 100 also comprises a distribution system 22, via which the distribution material is conveyed from one of the storage containers 12, 14 to the metering devices 26 using the conveyor airflow FLS.

The distribution system 22 comprises a main distribution unit 24, which is arranged below the storage containers 12, 14. The distribution material carried in the storage containers 12, 14 can be fed into the main distribution unit 24 under the influence of gravity. The conveyor airflow FLS generated by the conveyor airflow generator 18 is also fed into the main distribution unit 24 via the conveyor air line 28. The main distribution unit 24 is configured to divide the distribution material into several partial conveyor airflows FLTS generated from the conveyor air.

When metering fine seeds, such as rapeseed, there is a risk that, if the conveyor airflow is reduced or absent, the distribution material will flow against the conveying direction toward the conveyor airflow generator 18 due to the metering airflow. The conveyor airflow generator 18 can be damaged by backflowing distribution material. In addition, the distribution material can be unintentionally expelled out of the conveyor airflow generator 18 and thus end up on the agricultural field in an uncontrolled manner. To prevent this, the metering system 10 comprises a backflow prevention device 32, which, when the conveyor airflow FLS is reduced or absent, prevents the distribution material located in the distribution system 22 from being fed into the conveyor airflow generator 18 of the device assembly 16 via one or more metering airflows flowing in the opposite direction to the conveying direction. Damage to the conveyor airflow generator 18 by backflowing distribution material is effectively prevented by the backflow prevention device 32. Unintentional expulsion of distribution material from the conveyor airflow generator 18 is also prevented.

The metering system 10 also comprises a control device 30. The control device 30 comprises an electronic data processing device. The metering process performed by the metering system 10 can be adjusted via the control device 30. The backflow prevention device 32 can be provided either as a passive, non-controllable component or as an actively controllable component. If the backflow prevention device 32 is actively controllable, the air supply line 28 can be blocked and unblocked by means of control commands via the electronic control device 30. If the backflow prevention device 32 is provided as a passive, non-controllable component, the open state of the backflow prevention device 32 can, for example, depend on the direction of flow or inflow.

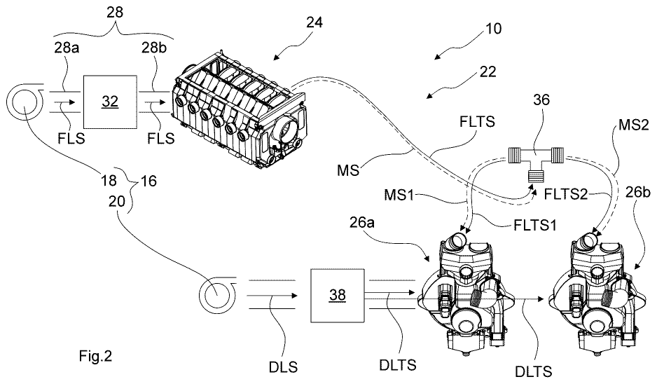

FIG. 2 shows a metering system 10 in which a conveyor airflow FLS is generated by means of a conveyor airflow generator 18 of a device assembly 16. The conveyor airflow FLS is fed into the backflow prevention device 32 via the line section 28a of the conveyor air line 28. From the backflow prevention device 32, the conveyor airflow FLS is fed into the main distribution unit 24 of the distribution system 22 via the line section 28b. The conveyor airflow FLS flows through the backflow prevention device 32 in the conveying direction, wherein the backflow prevention device 32 is configured not to exert any blocking effect when flow occurs in the conveying direction.

The main distribution unit 24 comprises an air inlet opening for the conveyor airflow FLS. Furthermore, the main distribution unit 24 comprises an upper material inlet opening for the distribution material. Within the main distribution unit 24, the conveyor airflow FLS is divided into a plurality of partial conveyor airflows FLTS, whereby for reasons of representation only one partial conveyor airflow FLTS is shown. The partial conveyor airflows FLTS emerging from the main distribution unit 24 are loaded with the distribution material, resulting in material flows MS. The partial conveyor airflows loaded with the distribution material are divided again by a dividing device 36, resulting in the partial conveyor airflows FLTS1 and FLTS2 as well as the material flows MS1 and MS2. The partial conveyor airflow FLTS1 is fed into the metering device 26a. The partial conveyor airflow FLTS2 is fed into the metering device 26b.

The metering devices 26a, 26b are pneumatically operated. For the pneumatic operation of the metering devices 26a, 26b, a metering airflow generator 20 of the device assembly 16 generates a metering airflow DLS. The metering airflow DLS is fed into a metering airflow divider 38, which divides the metering airflow DLS into several metering partial metering airflows DLTS. The partial metering air metering airflows DLTS are then fed to a respective metering device 26a, 26b so that the respective metering device 26a, 26b can be operated by means of the partial metering air metering airflow DLTS fed to it.

The metering devices 26a, 26b can, for example, be separating devices which are operated with overpressure. In this case, the distribution material is seed, which is separated within the metering devices 26a, 26b using overpressure. The partial conveyor airflow FLTS and the partial metering airflow DLTS, which are supplied to the respective metering devices 26a, 26b, are combined in the metering device 26a, 26b and used to guide the metered distribution material in the direction of the agricultural field. The outlet openings of the metering devices 26a, 26b can, for example, each be connected to a discharge channel through which the metered distribution material is discharged in the direction of the agricultural field.

If the conveyor airflow FLS is reduced or absent, the distribution material can be conveyed by the partial metering airflows DLTS in the opposite direction to the conveying direction through the main distribution unit 24 towards the conveyor airflow generator 18. In this case, the backflow prevention device 32 arranged between the line sections 28a, 28b of the conveyor air line 28 prevents the distribution material from being fed into the conveyor airflow generator 18. Damage to the conveyor airflow generator 18 caused by the introduction of distribution material is thus effectively prevented. Furthermore, distribution material is prevented from reaching the agricultural field in an uncontrolled manner via the conveyor airflow generator 18.

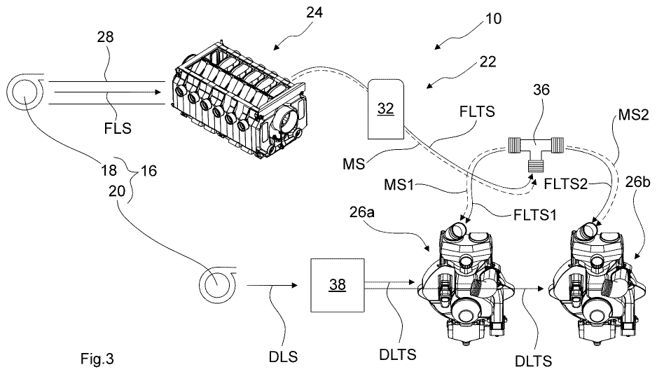

FIG. 3 shows a metering system 10 in which the backflow prevention device 32 is arranged between the main distribution unit 24 and the metering devices 26a, 26b. In this configuration, several backflow prevention devices 32 are required in order to can completely prevent a backward flow of material in the direction of the conveyor airflow generator 18.

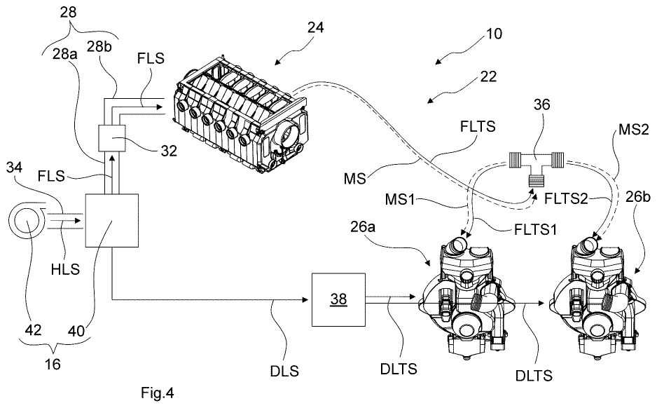

In the metering system 10 shown in FIG. 4, the conveyor airflow FLS and the metering airflow DLS are generated by a flow generator 42 of a device assembly 16. The flow generator 42 generates a main airflow HLS, which is fed via a main air line 34 to a flow divider 40 of the device assembly 16. The flow divider 40 divides the main airflow HLS into the metering airflow DLS and the conveyor airflow FLS.

In this case, the backflow prevention device 32 is arranged between the flow divider 40 and the main distribution unit 24 and prevents the distribution material located in the distribution system 22 from entering the flow divider 40 and the flow generator 42.

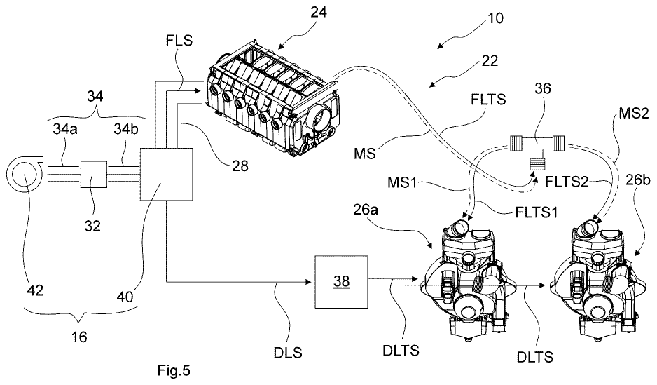

In the metering system 10 shown in FIG. 5, the backflow prevention device 32 is arranged between the line sections 34a, 34b of the main air line 34. The backflow prevention device 32 is therefore located between the flow divider 40 and the flow generator 42 and prevents the distribution material located in the distribution system 22 from being introduced into the flow generator 42. It is also conceivable that, in a non-illustrated embodiment, the backflow prevention device 32 is integrated into the flow divider 40, or that a single component performs both functions, or that the backflow prevention device 32 is part of the flow generator 42.

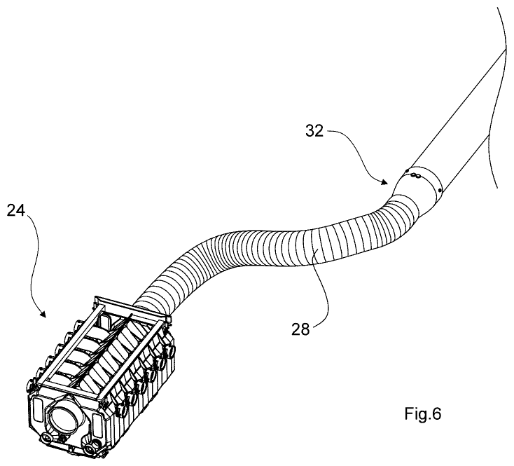

FIG. 6 shows a conveyor air line 28 leading into a main distribution unit 24. The conveyor air line 28 is equipped with a backflow prevention device 32.

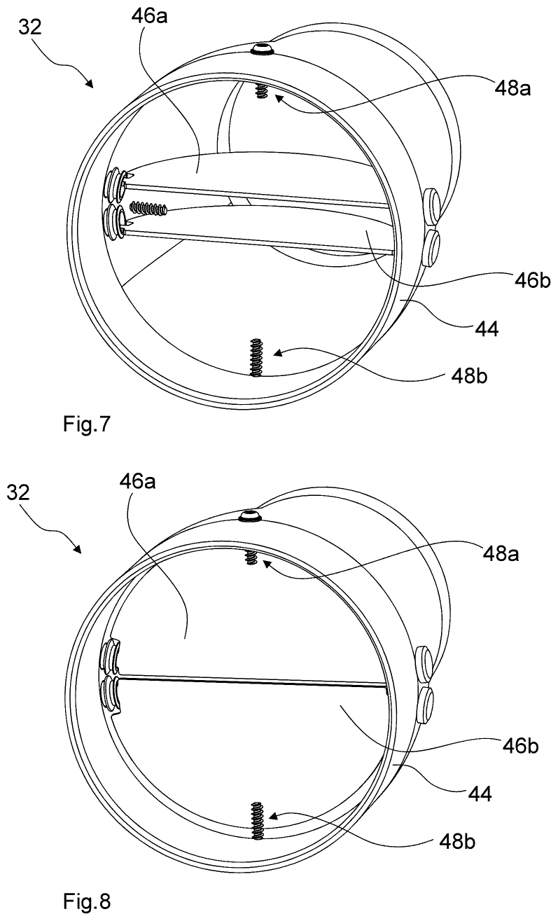

FIGS. 7 and 8 show that the backflow prevention device 32 comprises a pipe segment 44, wherein two movable blocking valves 46a, 46b are arranged in the free flow cross-section of the pipe segment 44. The free flow cross-section can be closed by means of the movable blocking valves 46a, 46b through the backflow prevention device 32. In this case, the backflow prevention device 32 is therefore provided as a passive component which cannot be controlled by an electronic control device. The blocking valves 46a, 46b are pivotable and rotatable in the flow cross-section.

FIG. 7 shows the backflow prevention device 32 in an open state. In the open state, the pivotable blocking valves 46a, 46b are aligned parallel to the direction of flow.

In FIG. 8, the backflow prevention device 32 is flowed through or flowed onto against the conveying direction, so that the blocking valves 46a, 46b essentially completely block the free flow cross-section. Stops 48a, 48b for the blocking valves 46a, 46b are located on the pipe segment 44. The stops 48a, 48b ensure that the blocking valves 46a, 46b are held in the closed position shown when flow is directed against the conveying direction.

The blocking valves 46a, 46b are therefore actuated solely by the airflow passing through the backflow prevention device 32, in particular depending on the conveying direction of the air. Alternatively, it would be conceivable for the blocking valves 46a, 46b to be actuated by at least one actuator.

Furthermore, in a non-illustrated embodiment, the blocking valves 46a, 46b can be replaced by a different type of blocking device. The blocking device comprises a flow resistance that depends on the conveying direction, so that the blocking device can be actuated, preferably exclusively, by the airflow passing through it.

This can be implemented in a technical way by the blocking device having a low flow resistance in the direction of flow, so that the conveyor airflow can pass through at least approximately without loss, whereas opposite to the direction of flow, the blocking device has a high flow resistance, so that an airflow comprising the distribution material is prevented.

The blocking device can comprise at least one membrane, partial spherical shell, eccentric flap, lamella, or grid.

### REFERENCE NUMERALS

10 metering system
12 storage container
14 storage container
16 device assembly
18 conveyor airflow generator
20 metering airflow generator
22 distribution system
24 main distribution unit
26, 26a, 26b metering devices
28 conveyor air line
28a, 28b line sections
30 control device
32 backflow prevention device
34 main air line
34a, 34b line sections
36 dividing device
38 metering airflow divider
40 flow divider
42 flow generator
44 pipe segment
46a, 46b blocking valves
48a, 48b stops
100 distribution machine
102 main frame
104 implement carrier
DLS metering airflow
DLTS partial metering airflow
FLS conveyor airflow
FLTS, FLTS1, FLTS2 partial conveyor airflows
MS, MS1, MS2 material flows
HLS main airflow

1. A metering system for an agricultural distribution machine, comprising:
a device assembly comprising at least one flow generator for generating a conveyor airflow flowing in a conveying direction and a metering airflow;
a metering device which is configured to meter distribution material using a partial metering airflow (DLTS) generated from the metering airflow;
a distribution system via which distribution material can be conveyed from a storage container to the metering device using the conveyor airflow; and
a backflow prevention device configured to, in the event of a reduced or absent conveyor airflow, prevent the introduction of distribution material located in the distribution system into the flow generator of the device assembly via one or more partial metering airflows flowing in a direction opposite to the conveying direction.

2. The metering system according to claim 1, wherein the backflow prevention device comprises at least one movable or deformable blocking valve by which a free flow cross-section through the backflow prevention device can be partially or completely closed.

3. The metering system according to claim 1, wherein the backflow prevention device is configured to be actuated by the airflow passing through the backflow prevention device.

4. The metering system according to claim 1, wherein the backflow prevention device comprises an actively controllable actuator for opening and/or closing the backflow prevention device.

5. The metering system according to claim 1, wherein the distribution system comprises a main distribution unit into which the distribution material and the conveyor airflow can be introduced and which is configured to divide the distribution material into several partial conveyor airflows generated from the conveyor air.

6. The metering system according to claim 5, wherein the device assembly comprises a conveyor airflow generator for generating the conveyor airflow and a metering airflow generator for generating the metering airflow,
wherein the backflow prevention device is arranged between the conveyor airflow generator of the device assembly and the main distribution unit of the distribution system.

7. The metering system according to claim 5, wherein the backflow prevention device is arranged between the main distribution unit of the distribution system and the metering device.

8. The metering system according to claim 5, wherein the device assembly comprises a flow generator for generating a main airflow and a flow divider for generating the conveyor airflow and the metering airflow from the main airflow.

9. The metering system according to claim 8, characterized in that the backflow prevention device is located between the flow divider of the device assembly and the main distribution unit of the distribution system or between the flow generator of the device assembly and the flow divider of the device assembly.

10. The metering system according to
claim 1, wherein the metering device is provided as an over-pressure-operated metering device.

11. A method for metering distribution material using the metering system according to claim 1, comprising:
generating a conveyor airflow flowing in the conveying direction and a metering airflow by means of a device assembly of the metering system comprising at least one flow generator;
metering of distribution material by means of a metering device of the metering system using a partial metering airflow generated from the metering airflow; and
conveying distribution material from a storage container to the metering device by means of a distribution system of the metering system using the conveyor airflow; and
preventing the distribution material located in the distribution system from being introduced into the flow generator of the device assembly when the conveyor airflow is reduced or absent via one or more partial metering airflows flowing in direction opposite to the conveying direction by the backflow prevention device of the metering system.

12. The method according to claim 11, wherein,
the backflow prevention device is actuated by the airflow flowing through the backflow prevention device; and/or
an actuator of the backflow prevention device is actively controlled to open and/or close the backflow prevention device.

13. The method according to claim 11, where the distribution material and the conveyor airflow are introduced into a main distribution unit of the distribution system, which divides the distribution material into several partial conveyor airflows generated from the conveyor airflow,
wherein a return flow of the distribution material is prevented by the backflow prevention device
between a conveyor airflow generator of the device assembly and the main distribution unit of the distribution system; or
between the main distribution unit of the distribution system and the metering device.

14. The method according to claim 11, wherein the device assembly comprises a flow generator for generating a main airflow, and the conveyor airflow and the metering airflow are generated from the main airflow by a flow divider, wherein a return flow of the distribution material is prevented by the backflow prevention device
between the flow divider of the device assembly and the main distribution unit of the distribution system; or
between the flow generator of the device assembly and the flow divider of the device assembly.
